(19) United States
(12) Patent Application Publication
(10) Pub. No.: US 2018/0049848 A1
(43) Pub. Date: Feb. 22, 2018

(54) DENTAL SCAN POST AND MANUFACTURING PROCESS THEREOF

(71) Applicant: MIS IMPLANTS TECHNOLOGIES LTD., MP MIsgav (IL)

(72) Inventor: Yaakov Levy, Gilon (IL)

(21) Appl. No.: 15/558,083

(22) PCT Filed: Mar. 23, 2016
(86) PCT No.: PCT/IL2016/050307

§ 371 Date: Sep. 13, 2017

(30) Foreign Application Priority Data
Mar. 25, 2015 (IL) 237946

(51) Int. Cl. A61C 8/00; A61C 9/00

(52) U.S. Cl. CPC A61C 8/0001; A61C 9/0053

(57) ABSTRACT

There is provided a scan post for a system of planning and producing oral or maxillofacial restorative products. The scan post comprises a body made of titanium or stainless steel, and at least a portion of the surface of the body is surface-treated using the following steps: sand blasting the treated surface to obtain surface roughness Ra of about 1.5 um-2.5 um, and coating the treated surface using Physical Vapor Deposition (PVD) or Chemical Vapor Deposition (CVD) process. The coating deposits on the treated surface a layer of one from the group consisting of chrome, chrome-nityrtide, aluminum nitride and titanium nitride. The surface treating may include after the step of sand blasting and before the step of coating, an intermediate step of rinsing the body with acid to remove sand leftovers from the scan post.

### FIELD OF THE INVENTION

The invention, in some embodiments, relates to the field of oral, dental and maxillofacial medical procedures, and more particularly, but not exclusively, to scan posts, also known as position locators or jigs, used as dental position indicators detectable by optical scanning for position determination.

### BACKGROUND OF THE INVENTION

Dental or maxillofacial restoration procedures often require construction of a computerized model of the patient's mouth and jaws, and using the model for accurately fitting an implant—e.g. a dental implant—or an artificial tooth for the patient. According to some techniques an optical scanning apparatus is used to scan the oral cavity whereas backscattered light is detected and the collected data is processed and used to construct the exact position of the oral cavity. For example, U.S. Pat. No. 6,590,654 discloses a conoscopic holographic scanning systems and related methods for that purpose.

Scan posts, also known as dental position locators, are used to identify in the computerized model a position and orientation of interest—for example a position and orientation of a dental implant—to enable accurate reconstruction of an artificial tooth that will be mounted onto the implant. Optical scanning of the oral cavity may be carried out whereas such a dental position locator is temporarily inserted into an implant in the mouth, and the position and orientation of the position locator is detected and recorded, indicating precisely the position and orientation of the implant inside which the locator is introduced.

EP2130514 discloses a position locator for a system of planning and producing oral or maxillofacial restorative products. An outer surface of the position locator is detectable by an optical scanner apparatus for determining the position and orientation of the outer surface. The outer surface is optically more diffusive reflective than specularly reflective. A layer of poorly reflective material is deposited onto the outer surface of the position locator.

It is known by professionals in the field to implement an occlusion spray to reduce specular reflection from a position locator and to enhance its diffusive reflection.

EP2400917 discloses a position locator for a system of planning and producing oral or maxillofacial restorative products. The position locator is made of an optically opaque metal, and comprises at least one outer surface detectable by an optical scanner apparatus for determining at least one of a position and orientation of the outer surface. A metal oxide layer is deposited onto the outer surface of the position locator by anodic oxidation, optically rendering the outer surface more diffusive reflective than specularly reflective.

### SUMMARY OF THE INVENTION

Aspects of the invention, in some embodiments thereof, relates to the field of oral, dental and maxillofacial medical procedures. More specifically, aspects of the invention, in some embodiments thereof, relate to scan posts, also known as position locators, used as dental position indicators detectable by optical scanning for position determination.

Position locators for use with an optical scanning apparatus as described above are required to provide high mechanical precision and particular optical properties as described herein below. Both mechanical precision and suitable reflectance characteristics are required to enable high positional accuracy of a model which is constructed or reconstructed based on the optical signals received from the position locators by the scanning apparatus. Optically, the position locator should have high reflectance (and therefore low light absorption), which is mostly (or wholly) diffusive and not specular. If the reflectance is mostly specular, most of the reflected energy is concentrated along a specific direction which is dictated by the relative orientation of the incident light beam and the reflecting surface, and therefore is arbitrary relative to the direction of a light detector of the scanning apparatus. As a result, in the general situation, a detector is likely to receive only a negligible signal from a specularly reflecting object. If the reflectance is however mostly diffusive, light is scattered from the reflecting surface towards a wide range of directions and therefore a sufficient amount of reflected light may be scattered from the object towards the direction of the detector.

Position locators made of plastic (or such that their light-reflecting part is made of plastic) provide good optical characteristics in that light reflections therefrom is mostly diffusive. However plastic is relatively soft and therefore allows relatively lower mechanical precision during manufacturing, compared for instance to mechanical precision attained with hard metal. Also, plastic position locators might twist or structurally distort during use (e.g. during mounting onto a dental implant), resulting in degrading the attainable positional accuracy provided by the position locator.

Position locators sprayed by occlusion spray may suffer the following deficiencies: spraying the paint is causes dirt; the coating thickness is not uniform enough to meet the precision required from the position locator, and also, the paint might wiped away during washing, rinsing or sterilization procedures. Needless to say that spraying during intra-oral scan is uncomfortable to the patient since the position locator body must not be touched during the scanning procedure.

Position locators made of metal such as Titanium (Ti) or stainless steel (SS) may provide excellent mechanical precision. However mechanical processing (such as cutting, turning or milling) that provide such high mechanical precision also results in smooth surface of the processed part, rendering the processed position locator mostly specularly reflecting and therefore unsuitable for use with an optical scanning apparatus.

There is thus provided according to an aspect of some embodiments a scan post for a system of planning and producing oral or maxillofacial restorative products, characterized in that the scan post comprises a body made of Titanium, and at least a portion of the surface of the body is surface-treated using the following steps:

sand blasting the treated surface to obtain surface roughness Ra of about 1.5 um-2.5 um, and

coating the treated surface using Physical Vapor Deposition (PVD) process or Chemical Vapor Deposition (CVD), by a layer of one from the group consisting of chrome, chrome-nityrtide, aluminum nitride and titanium nitride.

The term “about” as used herein with reference to specified numbers indicates possible relative deviations from the specified numbers of up to plus or minus 10%.

According to some embodiments the surface treating includes after the step of sand blasting and before the step of coating, an intermediate step of rinsing the body with acid to remove sand leftovers.

According to some embodiments the body of the scan post extends along a longitudinal axis between a first end and a second end. The body has on the first end a connection interface portion for connecting to a dental implant or dental implant replica, and on the second end a conical portion, pointing towards the connection interface portion. The body further comprises a cylindrical portion extending between the connection interface portion and the conical portion, and a through hole extending between the first end and the second end.

According to some embodiments the surface treatment is applied to the conical portion and to the cylindrical portion but not to the connection interface portion.

According to some embodiments the conical portion is sectioned by at least one cone section proximal the second end. According to some embodiments the cone sections comprise a parallel section extending parallel to the longitudinal axis. According to some embodiments the cone sections further comprise two tilted cone sections arranged symmetrically on both sides of said parallel cone section and being tilted relative to said longitudinal axis.

According to some embodiments the through hole comprises an internal shoulder facing the second end and configured to support a bolt disposed in the through hole through the second end and extending beyond the first end for connecting the scan post to a dental implant or a dental implant replica.

Certain embodiments of the present invention may include some, all, or none of the above advantages. Further advantages may be readily apparent to those skilled in the art from the figures, descriptions, and claims included herein. Aspects and embodiments of the invention are further described in the specification herein below and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1A schematically depicts an embodiment of a scan post according to the teachings herein, from a perspective view;

FIG. 1B schematically depicts the scan post of FIG. 1A from a side view;

FIG. 1C schematically depicts the scan post of FIG. 1A from a front view;

FIG. 1D schematically depicts the scan post of FIG. 1A from a top view;

FIG. 2A schematically depicts the scan post of FIG. 1A in a cross-sectional view;

FIG. 2B schematically depicts the scan post of FIG. 1A, with a screw inserted in the through-hole thereof, in a cross-sectional view;

FIG. 2C schematically depicts, in a cross-sectional view, the scan post of FIG. 1A, with a screw disposed in the through hole and being used to connect the scan post to a dental implant, and

FIG. 2D schematically depicts, in a cross-sectional view, the scan post of FIG. 1A, with a screw disposed in the through hole and being used to connect the scan post to a dental implant replica.

### DETAILED DESCRIPTION OF SOME EMBODIMENTS

The principles, uses and implementations of the teachings herein may be better understood with reference to the accompanying description and figures. Upon perusal of the description and figures present herein, one skilled in the art is able to implement the teachings herein without undue effort or experimentation. In the figures, like reference numerals refer to like parts throughout.

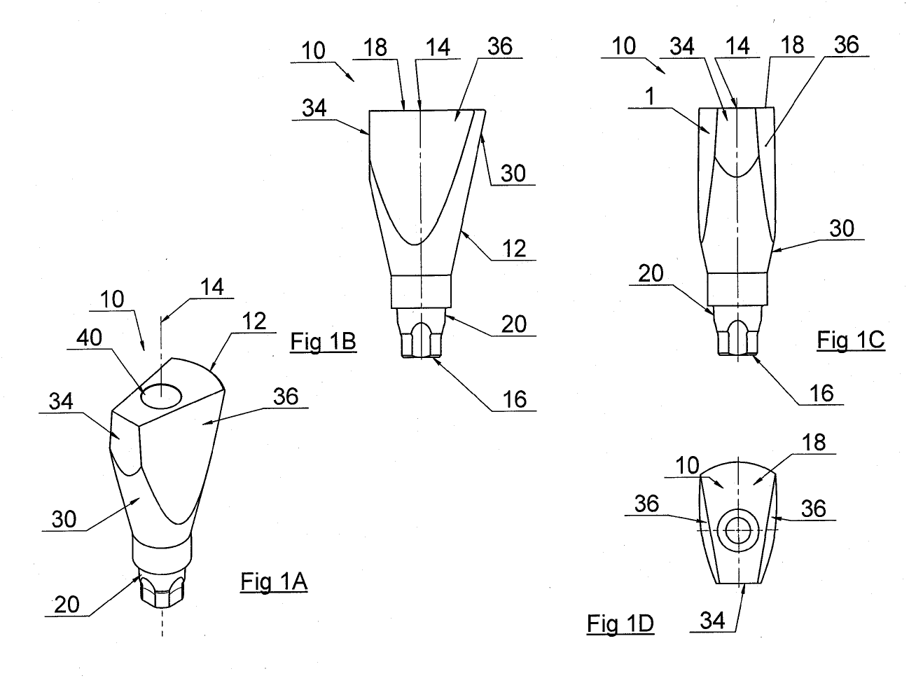

FIGS. 1A-1D schematically depicts an embodiment of a scan post 10 according to an aspect of some embodiments. FIG. 1A schematically depicts scan post 10 from a perspective view, whereas FIGS. 1B, 1C and 1D schematically depict scan post 10 from a side view, from a front view and from a top view, respectively.

Scan post 10 is made of metal, possibly titanium (Ti) grade 5 or 23 or stainless steel (SS). Scan post 10 has a body 12 extending along a longitudinal axis 14 of the scan post, between a first end 16 and a second end 18. Scan Body 12 comprises on first end 16 a connection interface portion 20, for connecting to a dental implant or dental implant replica as is further detailed herein below. Any professional in the field know that connection interface portion 20 may be formed with a circumferential multi-planes pattern (e.g.—hexagonal) or other known patterns (e.g.—conical) adapted to be fitted within matching dent formed in a dental implant or a dental implant replica. Body 12 further comprises on second end 18 a conical portion 30, pointing towards connection interface portion 20. A cylindrical portion 32 of body 12 extends between connection interface portion 20 and conical portion 30. By conical portion 30 being pointing towards connection interface portion 20 it is meant that conical portion 30 has its narrow base closer to connection interface portion 20, whereas its wide base is further away from connection interface portion 20. In body 12, the narrow base of conical portion 20 adjoins cylindrical portion 32, whereas the wide base of conical portion 20 coincides with second end 18 of body 12.

Conical portion 30 is sectioned by three cone sections proximal second end 18. A parallel cone section 34 extends parallel to longitudinal axis 14. Tilted cone sections 36 are arranged symmetrically on both sides of parallel cone section 34 and are tilted relative to longitudinal axis 14.

parallel cone section 34 has a known geometry related to the connection interface portion 20, therefore the implant index position can be determined from the scanning information.

It is noted that cone sections 34 and 36 render scan post 10 a relatively narrow body, allowing to fit scan post 10 even between two teeth of a patient thereby enhancing usages options of the scan post by the physician.

According to some embodiments a scanning code used to identify the scan post or the patient or provide any suitable identification, may be written, engraved or added onto the scan post, e.g. on the conical section or on one of the cone sections thereof.

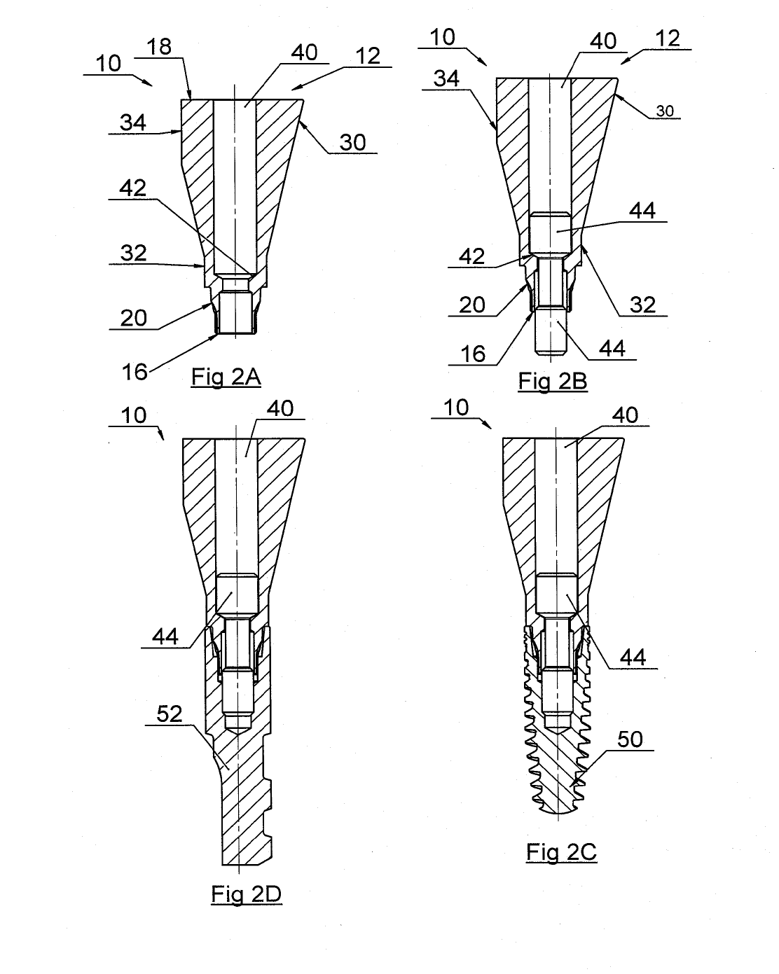

Body 12 further comprises a through-hole 40, extending along longitudinal axis 14 between first end 16 and second end 18, to accommodate a bolt such as a screw or rivet for connecting the scan post to an implant or an implant analog. FIGS. 2A-2D schematically depict scan post 10 in cross-sectional views. FIG. 2A schematically depicts scan post 10 without a screw. Through-hole 40 comprises an internal shoulder 42 facing second end 18, so that through-hole 40 is wider above internal shoulder 42 (that is to say, closer to second end 18) than below internal shoulder 42. Internal shoulder 42 is configured to support a bolt such as a screw or rivet disposed in the through hole from above, namely through the second end 18, as is further described and detailed below.

FIG. 2B schematically depicts scan post 10 with a screw 44 disposed in the through hole from above, being supported on internal shoulder 42 and extending beyond first end 16 for connecting scan post 10 to a dental implant or a dental implant replica (not shown in this Figure). FIG. 2C schematically depicts scan post 10 with screw 44 disposed in the through hole and being used to connect scan post 10 to a dental implant 50. FIG. 2D schematically depicts scan post 10 with screw 44 disposed in through hole 40 and being used to connect scan post 10 to a dental implant replica 52.

When an incident light beam is reflected from a surface of an opaque object, the reflectance has several components, the relative magnitude of which depending on the properties of the reflecting surface, such as its roughness. Three significant components are specular reflection, specular lobe and a diffuse lobe.

From an optically polished surface (e.g. Ra is smaller than about 0.01 um) or a smooth surface (e.g. Ra is smaller than about 0.2 um), the incident light may be reflected according to the law of reflection. The specular lobe and the diffuse lobe have relatively negligible magnitude, whereas the specular reflection contains most, or substantially all (in case of an optically polished surface) of the reflected energy from the surface. In these cases backscattering (that is to say—reflectance in the opposite direction to the incident beam) is generally practically zero, and an optical detector positioned proximal the source of the light may not detect a signal. Therefore, an optically polished surface or a smooth surface are not suitable for a scan post as described herein.

Nonetheless, light reflected from rough surfaces (having e.g. Ra greater than about 1 um) is characterized by significant specular lobe and diffuse lobe, and negligible specular reflection. A rough surface may therefore be more diffusive reflective than specularly reflective, and generate a significant backscattering to an incident light beam, allowing a detector positioned proximal the source of the light to detect a signal and hence to detect the reflecting surface. It is therefore an object of some embodiments of the current invention to provide a scan post having a treated surface so as to enhance optical reflection as is further explained below.

According to some embodiments a scan post of the current invention is surface-treated to enhance optical reflection therefrom so that the treated surface is more diffusive reflective than specularly reflective. According to some embodiments a metallic bulk—Titanium (Ti) or stainless steel (SS), is machined according to any suitable technique known in the art—e.g. by cutting and/or turning and/or milling—to produce a scan post having for example body 12 of scan post 10 as described above. After the machining step the outer surface of the scan post may have a surface roughness (Ra) of about 0.1-0.2 um. As discussed above, such low surface roughness may render the surface more specularly reflective than diffusive reflective, and hence unsuitable to be used with a scanning apparatus.

According to some embodiments, the machined scan post is then surface treated to obtain surface roughness (Ra) of about 1.5-2.5 um. According to some embodiments the surface of the scan post is treated by sand blasting. According to some embodiments the grains of the sand which is used for the sand blasting are filtered or otherwise selected to have a suitable range of sizes for obtaining the required surface roughness. According to some embodiments sand blasting is applied only to the conical portion 30 and to the cylindrical portion 32 of body 12 of the scan post. According to some embodiments sand blasting is not applied to connection interface portion 20, thus maintaining connection interface portion 20 relatively smooth and thereby avoiding injuries or damage to a patient's gingival tissue when the scan post is screwed into a dental implant in the patient's mouth.

According to some embodiments the scan post is further treated in acid, e g immersed in acid or rinsed with acid, following said step of sand blasting. According to some embodiments the step of acid-treating the surface of the scan post removes sand leftovers from the surface and prepares the surface to accept a coating thereon.

According to some embodiments at least a portion of the outer surface of the scan post is then coated with a metal or with ceramic, to enhance light reflection therefrom. According to some embodiments coating is applied only to the conical portion 30 and to the cylindrical portion 32 of body 12 of the scan post. According to some embodiments coating is not applied to connection interface portion 20. According to some embodiments coating is applied using a Physical Vapor Deposition (PVD) or Chemical Vapor Deposition (CVD) process. According to some embodiments the coating material may comprise chrome or chrome nitride or aluminum nitride or titanium nitride.

Any professional will understand that in addition, position locator in accordance with the invention, may also be formed with a digital scanning code (indicium) on the locator's body allowing for an immediate digital scan of the indicium (providing for example' manufacturer' design type and other information specifically allocated to the specific locator.

The inventors of the current invention have carried out an extensive comparative test and measured the quality and accuracy of the signal received from two representing position locators currently available on the market and from a metallic scan post according to the teachings herein. The quality of the received signal was measured with 10 different optical scanner apparatuses available on the market, from six different manufacturers. The results of the comparative test are summarized in the table below, wherein a grade “A” indicates high quality of the received signal from the position locator, that is to say such light reflections that allow the optical scanner to accurately and validly determine the position of the position locator. A grade “B” indicates medium quality of the received signal, and grade “C” indicates low quality of the received signal. The first position locator represented in the left column, is made of plastic. The second position locator, represented in the middle column, is made of titanium and apparently was surface-treated, possibly by etching. The third position locator, represented in the right column of the table is an embodiment of scan post 10 as described herein. The surface of the conical portion 30 and the cylindrical portion 32 was treated by sand blasting to obtain surface roughness of Ra of about 1.5-2 um. After sand blasting, the outer surface of the scan post was coated by titanium nitride layer of thickness of about 2-3 um, using a PVD process.

The comparative test results show that the plastic position locator provide high quality of the received signal with all 10 apparatuses that were used in the test. The metallic (titanium in this case) position locator provide low quality of the received signal with 3 of the tested optical scanners, medium quality with two scanners, and high quality with only 5 of the scanners used in the test. The scan post of the invention provide high quality of the received signal with 9 optical scanners and medium quality signal with the 10^{th}.

| | | Position locator | Scan |
|---|---|---|---|
| | Position locator | (metallic + anodized | post of the |
| Optical Scanner | (Plastic) | coating) | Invention |
| Manufacturer A | A | C | B |
| Product 1 | | | |
| Manufacturer B | A | A | A |
| Product 2 | | | |
| Manufacturer C | A | C | A |
| Product 3 | | | |
| Manufacturer D | A | B | A |
| Product 4 | | | |
| Manufacturer E | A | B | A |
| Product 5 | | | |
| Manufacturer E | A | C | A |
| Product 6 | | | |
| Manufacturer F | A | A | A |
| Product 7 | | | |
| Manufacturer F | A | A | A |
| Product 8 | | | |
| Manufacturer F | A | A | A |
| Product 9 | | | |
| Manufacturer F | A | A | A |
| Product 10 | | | |

It is thus concluded that the scan post of the invention provides a combination of low-tolerance, high precision metallic body, and superior surface treatment, rendering the scan post best suited for use with an optical scanning apparatus for position determination.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

1-9. (canceled)

10. A scan post for a system of planning and producing oral or maxillofacial restorative products, characterized in that the scan post comprises a body made of either Titanium (Ti) or stainless steel (SS) metal, and at least a portion of the surface of the body is surface-treated using the following steps:
sand blasting the treated surface to obtain surface roughness Ra of about 1.5 um-2.5 um, and
coating the treated surface using either Physical Vapor Deposition (PVD) or Chemical Vapor Deposition (CVD) process, by a layer of one from the group consisting of chrome, chrome-nityrtide, aluminum nitride and titanium nitride.

11. The scan post of claim 10, wherein the surface treating includes after the step of sand blasting and before the step of coating, an intermediate step of rinsing the body with acid to remove sand leftovers.

12. The scan post of claim 10, wherein said body extends along a longitudinal axis between a first end and a second end and having on said first end a connection interface portion for connecting to a dental implant or dental implant replica, and on said second end a conical portion, pointing towards said connection interface portion, said body further comprising a cylindrical portion extending between said connection interface portion and said conical portion, said body having a through hole extending between said first end and said second end.

13. The scan post of claim 12, wherein surface treatment is applied to said conical portion and to said cylindrical portion but not to said connection interface portion.

14. The scan post of claim 12, wherein said conical portion is sectioned by at least one cone section proximal said second end.

15. The scan post of claim 14, wherein said cone sections comprise a parallel section extending parallel to said longitudinal axis.

16. The scan post of claim 15, wherein said cone sections further comprise two tilted cone sections arranged symmetrically on both sides of said parallel cone section and being tilted relative to said longitudinal axis.

17. The scan post of claim 12, wherein said through hole comprises an internal shoulder facing said second end and configured to support a bolt disposed in said through hole through said second end and extending beyond said first end for connecting said scan post to a dental implant or a dental implant replica.

18. A method of producing a scan post for use with a system of planning and producing oral or maxillofacial restorative products, the method comprises:
providing a body made of a first metal; and
sand-blasting at least a portion of the surface of the body to obtain a surface roughness thereof of Ra of about 1.5-2.5 um; and
coating the treated surface with a ceramic or a second metal different from the first metal using a PVD or CVD process, the coating having a thickness of about 2-3 um.

19. The method according to claim 18, wherein:
the provided body is formed as a body extending along a longitudinal axis between a first end and a second end, and having on the first end a connection interface portion for connecting to a dental implant or dental implant replica, and on the second end a conical portion, pointing towards the connection interface portion, the body further comprising a cylindrical portion extending between the connection interface portion and the conical portion, the body having a through hole extending between the first end and the second end; and
the sand-blasting is performed over the conical portion and the cylindrical portion of the provided body; and
the coating is performed over at least the conical portion of the provided body.

20. The method according to claim 18, wherein the method comprises an additional step, taken place between said sand-blasting and said coating stages, of:
rinsing the body with acid to remove sand leftover.
